(19) United States
(12) Patent Application Publication
(10) Pub. No.: US 2008/0150454 A1
(43) Pub. Date: Jun. 26, 2008

(54) Multi-Drive Motor

(76) Inventors: Masataka Ito, Aichi (JP); Yuichi Komazawa, Tokyo (JP); Tsutomu Nishibori, Aichi (JP)

Correspondence Address: BERENATO, WHITE & STAVISH, LLC, 6550 ROCK SPRING DRIVE, SUITE 240, BETHESDA, MD, 20817, US

(21) Appl. No.: 11/918,428

(22) PCT Filed: Oct. 3, 2006
(86) PCT No.: PCT/JP2006/319739

§ 371 Date: Oct. 12, 2007

(30) Foreign Application Priority Data
Jun. 5, 2006 (JP) 2006-156673

(51) Int. Cl. H02P 5/747

(52) U.S. Cl. 318/8

(57) ABSTRACT

The Objective of the present invention is to provide a multi-drive motor, which can easily fabricate responding to the design and reduce the backlash caused by meshing gears connecting to the rotation axis, comparing to the conventional motor.

The objective is solved by providing a the multi-drive motor comprises: a rotor 101 having an internal gear, a plurality of element motors 11˜14 for rotating a driving gear 102 meshing from the inside with the internal gear and thereby rotating the rotor 101, and a fixing flange 103, to which the rotor 101 is fixed rotatably and the element motors 11˜14 are fixed. The bearing 104 is sandwiched between the fixing flange 103 and the opposite outer ring flange 105, further sandwiched between rotor 101 and the inner ring flange 106, and thereby the rotor 101 is fixed on the fixing flange 103 rotatably. The outer ring flange 105 is fixed on the fixing flange with screws 107, and the inner flange 106 is fixed on the rotor 101 with screw 108.

### FIELD OF THE INVENTION

The present invention relates to a multi-drive motor, which is configured to rotate one rotor by using a plurality of element motors.

In recent years, as can be seen from the use in a conveyor, an AGV (Autonomous Guided Vehicle), a robot, etc., the use of a motor becomes diversified, and various new uses are generating. Conventionally, from the point of view of transferring a driving force, different kinds of motors are known: a DD (direct drive) motor directly transferring a torque and speed to the load, and a motor transferring a torque and speed adjusted by a gear reducer consisting of gears (so-called the motor with gear reducer) to the load.

Since a DD motor transfers a torque and speed directly to the load, a high rotation speed can be obtained, and it is adequate to the use in a robot and the like, which requires high accuracy of position control. In the meanwhile, since a DD motor of ordinary rotation type can not change its torque speed characteristic flexibly, motors of the so-called linear type, and the like has been developed (for example, refer to the patent document 1). FIG. 4 is a schematic view illustrating an arrangement of a conventional DD motor of linear type.

In the configuration shown in FIG. 4, a stator comprises an outer cylinder 1 and a magnetic coil 2 printed thereon, and a rotor comprises a cylindrical housing 4 with a magnet 3 formed thereon, and the rotor is attached to the cylinder 1 by way of a bearing 5 so as to be freely rotatable. The motor configured like this is available to rotate a camera lens and the like, and a load such as a lens 6, etc., is mountable inside the rotor.

In the meanwhile, since the motor with gear reducer transfers the torque and speed after the adjustment by the torque reducer to the load, it is relatively easy to obtain the torque speed characteristic suitable to the load. To be concrete, a motor with gear reducer can relatively easily achieve to decrease a speed with increasing a torque, and thereby can respond relatively flexibly to the use in a belt conveyor and the like, where a large load can be charged to the motor, depending on the load.

In recent years, with increasing diversity of the use of a motor, there are increasing demands such as the so-called brushless motor, a motor capable of providing a second rotation axis, and the like. As a motor meeting such demands, there has been developed a motor having a structure with an opening in the area to be passed by the rotation axis. Further, it becomes apparent that if this opening can be enlarged, the field of the use spreads more widely.

[Patent Document 1]

Japanese Patent Application Laid-Open Publication 2005-202316

### SUMMARY OF THE INVENTION

However, regarding the conventional motor of linear type, there are problems that parts used for them are peculiar and therefore getting them requires a long term and a high cost, and further there is usually a difficulty to divert a motor of the same linear type into that of different design. As a result, it is difficult to easily fabricate a motor and to flexibly respond the change of its design, and thereby causing a longer fabrication period and an increasing cost.

Besides, regarding the conventional motor with gear reducer, owing to the use of one or more gears for a gear reducer, there is a problem that the so-called backlash is large due to the play between the meshing gears. Owing to be driven by a large torque, the gear of the gear reducer must be usually thick so as to secure the mechanical strength. As a result, a very long period and/or a very high cost are required for fabricating the motor with gear reducer, which has an opening in an area to be passed by the rotation axis, and a small backlash.

Considering the aforementioned state of art, the objective of the present invention is to provide a multi-drive motor, which can be easily fabricated responding to the design and reduce the backlash caused by meshing gears connecting to the rotation axis, comparing to the conventional motor.

The aforementioned objective is achieved by the following configurations.

(1) According to the claim 1, there is provided a multi-drive motor comprising: a rotor having an internal gear, a plurality of element motors, each having a driving gear meshing from inside with said internal gear, for rotating said driving gear and thereby rotating said rotor, a fixing flange, to which said rotor is fixed rotatably and each element motor is fixed.

(2) According to the claim 2, there is provided a multi-drive motor according to claim 1, wherein said fixing flange has an opening in an area to be passed by the rotation angle of said internal gear.

(3) According to the claim 3, there is provided a multi-drive motor according to claim 1, wherein each element motor is fixed on the same surface of said fixing flange.

(4) According to the claim 4, there is provided a multi-drive motor according to claim 1, wherein said opening is either a circle with a diameter of 50 mm or more, or a polygon inscribed to the circle.

(5) According to the claim 5, there is provided a multi-drive motor according to claim 1, wherein each element motor is aligned so as that the position of its axis has a rotational symmetry with respect to the rotation axis.

(6) According to the claim 6, there is provided a multi-drive motor according to claim 1, wherein the total number of said element motors is 4.

(7) According to the claim 7, there is provided a multi-drive motor according to claim 3, wherein each element motor consists of an induction motor.

(8) According to the claim 8, there is provided a multi-drive motor according to claim 6, wherein each element motor is controlled with respect to the torque or speed.

According to the present invention defined in claim 1, since there is provided a multi-drive motor comprising: a rotor having an internal gear, a plurality of element motors, each having a driving gear meshing from inside with said internal gear, for rotating said driving gear and thereby rotating said rotor, a fixing flange, to which said rotor is fixed rotatably and each element motor is fixed, it is achievable to provide a multi-drive motor, which can easily be fabricated responding to the design and reduce the backlash caused by meshing gears connecting to the rotation axis, comparing to the conventional motor.

According to the present invention defined in claim 2, since aid fixing flange has an opening in an area to be passed by the rotation angle of said internal gear, it is achievable to eliminate brushes, realize double rotation mechanisms, and easily meet to the diversity of uses.

According to the present invention defined in claim 3, since each element motor is fixed on the same surface of said fixing flange, it is possible to meet the change of design, such as change of number of element motors, change of sizes, and the like, flexibly.

According to the present invention defined in claim 4, since said opening is either a circle with a diameter of 50 mm or more, or a polygon inscribed to the circle, it is possible to meet the diversity of the use, further easily.

According to the present invention defined in claim 5, since each element motor is aligned so as that the position of its axis has a rotational symmetry with respect to the rotation axis, it is possible to realize uniform load balance, and thereby further reducing the backlash.

According to the present invention defined in claim 6, since the total number of said element motors is 4, it is possible to secure a relatively large opening with a compact configuration of a multi-drive motor.

According to the present invention defined in claim 7, since each element motor consists of an induction motor, it is possible to configure using very easy available and cheap motors.

According to the present invention defined in claim 8, since each element motor is controlled with respect to the torque or speed, it is possible to simplify the control of the motor to the very compact one, such as the control of the driving current and the like.

### BRIEF DESCRIPTION OF THE DRAWINGS

FIG. 1 shows a front view, a side view and a rear view schematically illustrating the embodiment of a multi-drive motor according to the present invention.

FIG. 2 shows rear views illustrating configurations with three/six element motors.

FIG. 3 shows a circuit diagram for explaining drive and control of a multi-drive motor.

FIG. 4 shows a schematic view illustrating a conventional DD motor of linear type.

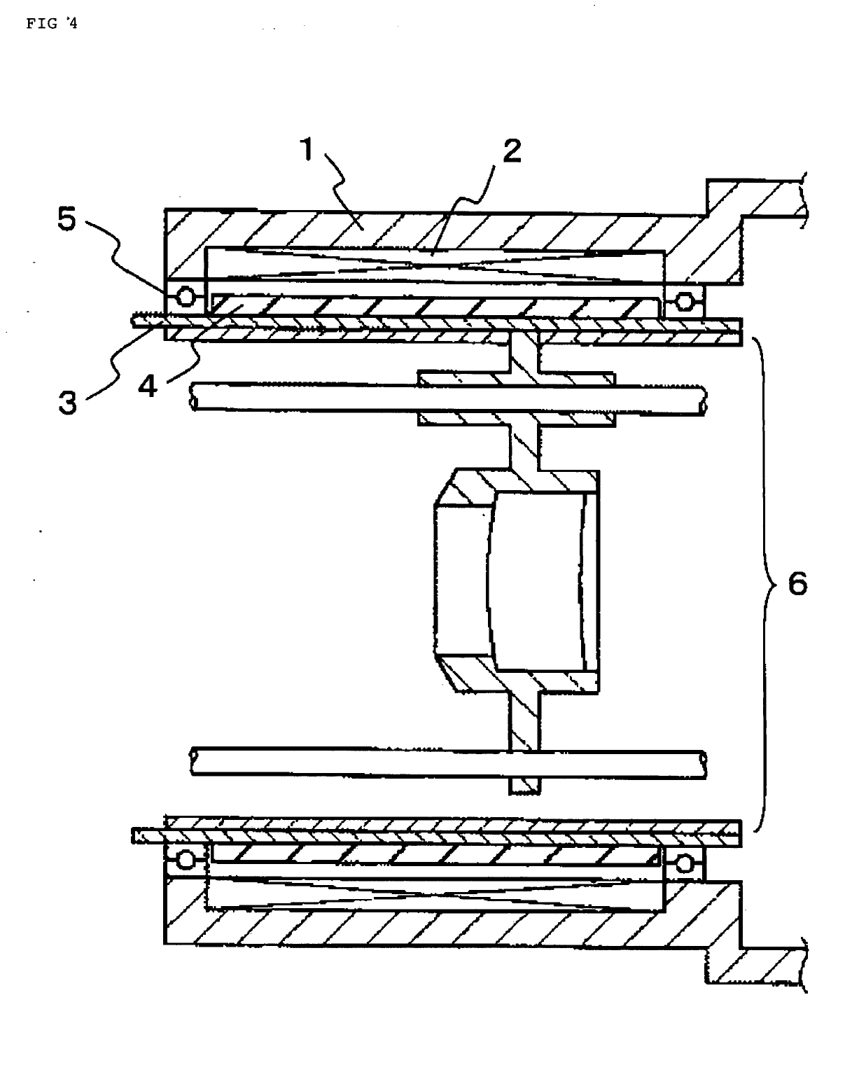

### DETAILED DESCRIPTION OF THE PREFERRED EMBODIMENTS

Hereinafter, the embodiments of the present invention will be described referring to the drawings illustrating embodiments.

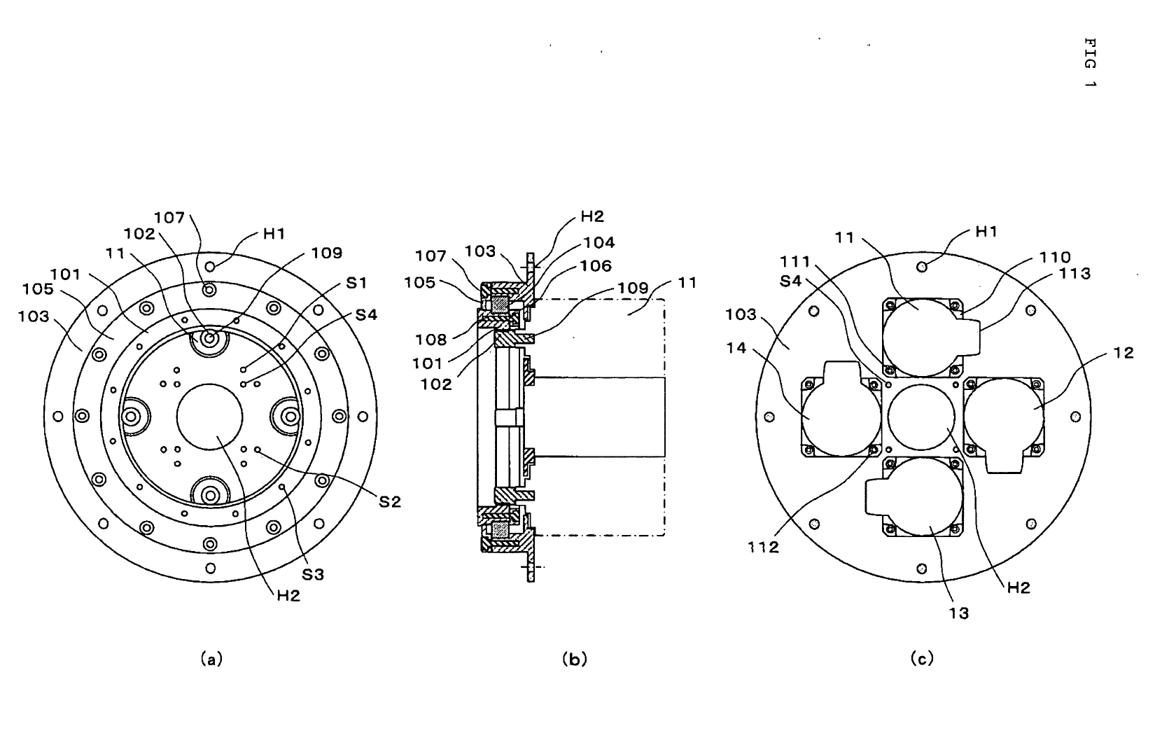

FIG. 1 is a view schematically illustrating an embodiment of a multi-drive motor according to the present invention: FIG. 1(a) is a front view, FIG. 1(b) is a side view, and FIG. 1(c) is a rear view. As shown in FIG. 1, the multi-drive motor comprises: a rotor 101 having an internal gear, a plurality of element motors 11˜14 for rotating its driving gear 102 meshing from the inside with the internal gear and thereby rotating the rotor 101, and a fixing flange 103, to which the rotor 101 is fixed rotatably and the element motors 11˜14 are fixed.

Hereat, the fixing flange 103 rotatably fixes the rotor 101 by way of bearing 104. To be concrete, the rotor 101 is fixed rotatably on the fixing flange 103 by sandwiching the bearing 104 between the fixing flange 103 and an opposite outer ring flange 105 and sandwiching the bearing 104 between the rotor 101 and an opposite inner ring flange 103. The outer ring flange 105 is fixed on the fixing flange 103 with screws 107, and the inner ring flange 106 is fixed on the rotor 101 with screws 108.

The fixing flange 103 is also arranged such that the element motors 11˜14 are fixed so as to align their axes 109 of the element motors 11˜14 on a circle with a center at the rotation axis of the internal gear (hereinafter, simply referred to as “rotation axis”). To be concrete, the element motor 11 is fixed on the fixing flange 103 with screws 111 and screw holes S1 formed in the fixing flange at four points, by screwing screws through the fixing portions 110 provided with the body on the frontal portion regarding its axis. A screw hole S2 corresponds to the aforementioned screw hole S1, and is provided to fix the element motor 12 on the fixing flange 103 with screw 12. Driving the rotor with a plurality of element motors allows to balance the load and thereby to reduce the torque on the screw of the internal screw. As a result, it makes it possible to shorten the pitch of the internal screw, and thereby reduce the backlash.

The multi-drive motor is screwed to a machine having a load to be rotated, through a through hole H1 formed near the outer edge portion of the fixing flange 103. A segment, a machine, and the like to be a load are screwed through screw holes formed in the rotor 101 to the rotor 101.

It is preferable that the fixing flange has an opening in the region surrounded by the elements motors, since this configuration is capable of meeting the diversity of uses. Although the opening shown in FIG. 1 has a circular shape, the shape of the opening is also allowable to be a polygonal shape. Further, the opening may be formed coaxially to the rotation axis. Moreover, in case that the opening has a circular shape, it is preferable that the inner diameter is 50 mm or more, 70 mm or more, etc., since this configuration is capable of meeting the diversity of uses. To be concrete, for use such as a robot, it is extremely preferable that the fixing flange 103 has a large opening, since there are many demands: for example, for providing with double rotation mechanisms to a joint and the like, and for passing electrical wires such as signal lines, power lines through the rotation mechanics without using brush. Regarding the example shown FIG. 1, through four screw holes S4 formed in the area around the opening H2, a motor having a size similar to that of the element motors 11˜14 is capable of being fixed to the fixing flange 103. It is apparent that when no motor is mounted on the area, electrical wires such as signal lines, power lines can be passed without brush.

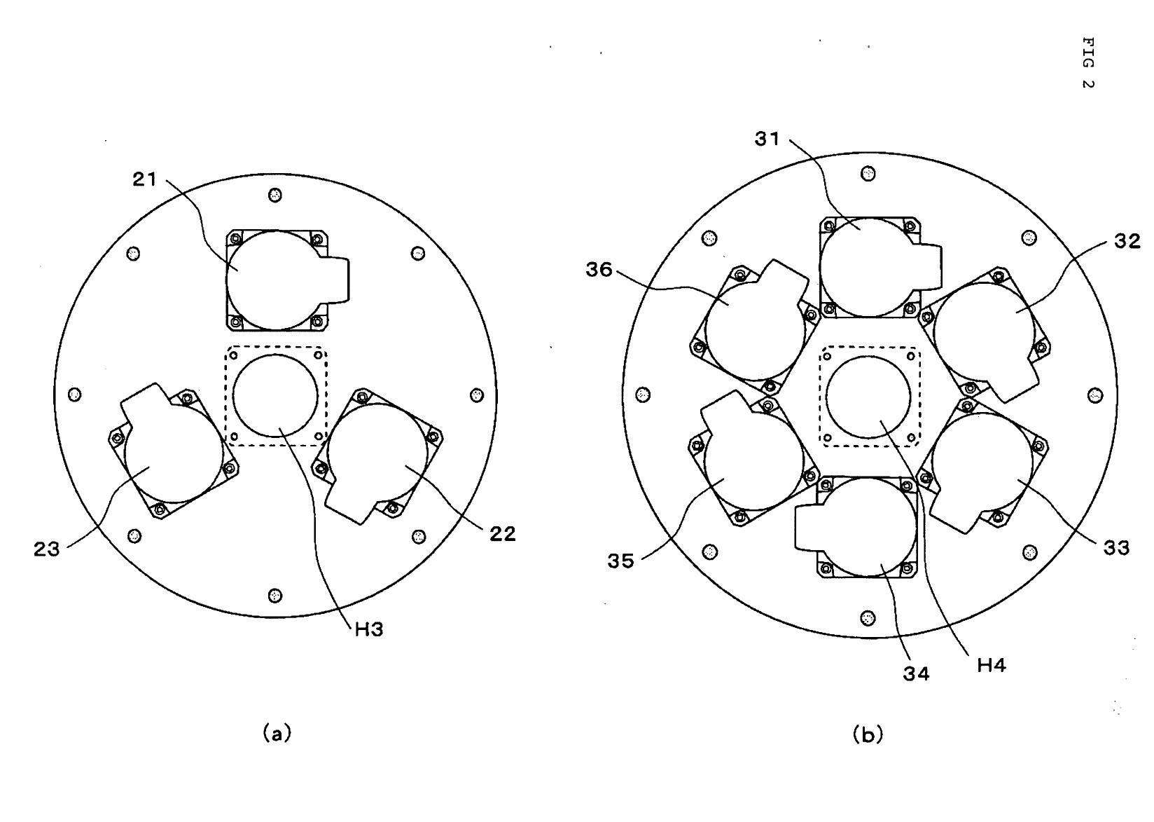

It is preferable to align the element motors 11˜14 so as that the positions of their axes 109 have rotational symmetry with respect to the rotation axis, since a load balance can be achieved among the element motors 11˜14 and the backlash can further be reduced. Regarding the configuration shown FIG. 1, four element motors 11˜14 are positioned with four rotational symmetry. The configuration is preferable, since relatively large opening can be secured together with a compact arrangement of the multi-drive motor. However, the number of element motors is changeable to the other except for four, depending on the design. FIG. 2 is a view illustrating the other configuration of the element motors. In FIG. 2, exemplary configurations, that positions of axes are aligned so as to have a rotationally symmetry, are shown; one has three element motors 21˜23, and the other has six element motors 31˜36.

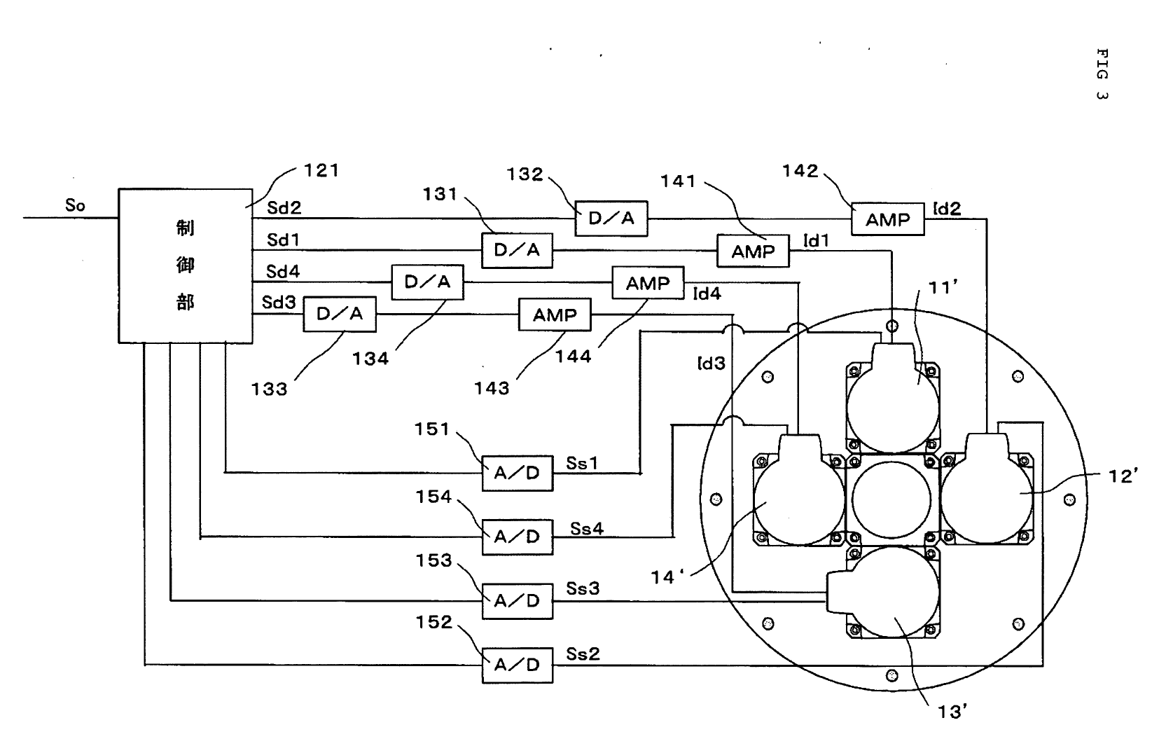

Hereinafter, the action of a multi-drive motor according to the present invention will be described with reference to the drawings. FIG. 3 is a circuit diagram for explaining the drive and the control of a multi-drive motor. To a multi-drive motor, for example as shown in FIG. 3, followings are connected: a control unit 121 to be input operations and for controlling, a D/A converter 131˜134 for converting a digital signal Sd1˜Sd2 output from the control unit 121 to an analogue signal, an amplifier 141˜144 for amplifying the converted analogue signal and outputting it as a drive current to the element motors 11′˜14′, an element motor sensor, not shown, for detecting the rotational state of the element motors 11′˜14′ and consisting of such as a position sensor, a speed sensor, and an A/D converter 151˜154 for converting output an analogue signal from the element motor sensor to a digital signal. Hereat, although the direction of the connecting terminal (shown with a symbol 113 in the FIG. 3.) extending from the element motors 11′˜14′ differs from that of the element motors 11˜14 shown in FIG. 1, the direction of the connecting terminal is determined depending on the wiring demand. Further, to the control unit 121, an instruction for starting rotation, a value for specifying the rotational speed, and the like are input by the user's operation.

When an operation is input, the input operation are converted by the control unit 121 to a signal for stating rotation of the element motors 11′˜14′, a set value for specifying the rotation state, and the like. Next, depending on the converted signal specifying the start of the rotation and the set value for specifying the rotation, and the like, a control signal is created by the control unit 121, and is output as a digital signal to the D/A converter 131˜134. The control signals Sd1˜Sd4 output to the D/A converter 131˜134 are converted by the D/A converter 131˜134 to analogue signals, output to the amplifiers 141˜144, amplified by the amplifiers 141˜144, output to the element motors 11′˜14′, and drive the element motors 11′˜14′. The information of a position, a rotational speed, and the like is detected by the element motor sensor, output to the A/D converter 151˜154, converted by the A/D converter 151˜154 to the digital signal, output to the control unit 121, compared with a set value by the control unit 121, and utilized to the control for approaching the rotational state of the element motors 11′˜14′ to the one specified by the set value.

Although, hitherto, descriptions are carried out on the embodiment, in which the control is performed using the element motor sensor consisting of a position sensor, a speed sensor, and the like, the element sensor is not always necessary depending on use, aim, and the like. Further, the control should not be limited to the one performed by using a digital circuit, and in a certain case, it may be performed by a sole analogue circuit. To be concrete, it may be possible to perform with a compact configuration, in which each element motor 11′˜14′ consists of induction motor, and each driving current is controlled so as to balance the torque of the element motor 11′˜14′. By configuring like this, since segments, machine, and the like can be easily available comparing with that used for a conventional motor, a higher rotational speed can be achievable, and the load can be balanced, it is easily achievable to maintain the speed, the torque, and the like above certain value and suppress the backlash.

What is claimed is:

1. A multi-drive motor comprising: a rotor having an internal gear,
a plurality of element motors, each having a driving gear meshing from inside with said internal gear, for rotating said driving gear and thereby rotating said rotor,
a fixing flange, to which said rotor is fixed rotatably and each element motor is fixed.

2. A multi-drive motor according to claim 1, wherein said fixing flange has an opening in an area to be passed by the rotation angle of said internal gear.

3. A multi-drive motor according to claim 1, wherein each element motor is fixed on the same surface of said fixing flange.

4. A multi-drive motor according to claim 1, wherein said opening is either a circle with a diameter of 50 mm or more, or a polygon inscribed to the circle.

5. A multi-drive motor according to claim 1, wherein each element motor is aligned so as that the position of its axis has a rotational symmetry with respect to the rotation axis.

6. A multi-drive motor according to claim 1, wherein the total number of said element motors is 4.

7. A multi-drive motor according to claim 1, wherein each element motor consists of an induction motor.

8. A multi-drive motor according to claim 1, wherein each element motor is controlled with respect to the torque or speed.
